(19) United States
(12) Patent Application Publication
(10) Pub. No.: US 2013/0170257 A1
(43) Pub. Date: Jul. 4, 2013

(54) COMPOSITE AC-TO-DC POWER CONVERTER USING WYE ARCHITECTURE

(71) Applicants: EVGENI GANEV, TORRANCE, CA (US); WILLIAM WARR, GLENDALE, CA (US); KEMING CHEN, TORRANCE, CA (US)

(72) Inventors: EVGENI GANEV, TORRANCE, CA (US); WILLIAM WARR, GLENDALE, CA (US); KEMING CHEN, TORRANCE, CA (US)

(73) Assignee: HONEYWELL INTERNATIONAL INC., MORRISTOWN, NJ (US)

(21) Appl. No.: 13/342,845

(22) Filed: Jan. 3, 2012

(51) Int. Cl. H02M 1/12; H02M 7/06

(52) U.S. Cl. 363/44; 363/64

(57) ABSTRACT

A composite power conversion method using a WYE asymmetrical autotransformer that converts electrical power from AC to DC uses two or more conversion methods in parallel and provides a passive technique that “splits” the input 3-phase voltages into additional phases, so that the number of DC rectification pulses is increased to improve AC line current THD The WYE asymmetric autotransformer topology provides a potential improvement in size/weight and efficiency compared to former asymmetric autotransformers.

### BACKGROUND OF THE INVENTION

The present invention relates to apparatus and methods for power conversion systems and methods and, more particularly, a composite alternating current (AC) to direct current (DC) power converter using wye architecture.

AC-to-DC converters play a significant role in the modern aerospace/military industry. This is particularly true in the area of more electric architecture (MEA) for aircraft and spacecraft.

The commercial aircraft business is moving toward MEA having no bleed-air environmental control systems (ECS), variable-frequency (VF) power distribution systems, and electrical actuation. A typical example of a platform utilizing the new architecture is the Boeing 787. The Airbus A350 airplane also incorporates a large number of MEA elements. In the future, the next generation Boeing airplane (the replacement for the 737) and the Airbus airplane (the replacement for the A320), will most likely make use of MEA. In addition, some military aircraft already utilize MEA for primary and secondary flight control, as well as for other functions.

Military ground vehicles have migrated toward hybrid electric technology, where the main propulsion is performed by electric drives. That change in approach is an example of a substantial emerging demand for increased power electronics for such purposes.

Another possible avenue for development is that future space vehicles will require electric power-generation systems for thrust vector and flight control actuation. These systems will have to be more robust and will have to offer greatly reduced operating costs and enhanced safety compared to recent Space Shuttle power systems.

These new aerospace and military trends have significantly increased electrical power generation needs. The overall result has been a significant new emphasis on meeting the challenges presented by the need to accommodate electrical equipment to the new platforms. This has led to increased operating voltages, along with efforts to reduce system losses, weight, and volume. A new set of electrical power quality and electromagnetic interference (EMI) requirements has been created to satisfy system quality and performance needs. One of the latest trends is utilizing MEA as a basis for energy-efficient aircraft in which electric power and heat management are inter-related. Therefore, overall system performance improvement and, more specifically, power density increases, are necessary for the new-generation hardware. This particularly applies to AC-to-DC conversion, which is a substantial contributor to the weight, volume, and cost of power-conversion electronics.

Power quality is a major concern for MEA aircraft because of the large number of electric power systems and equipment installed on the same bus. The power quality of these systems and equipment has much more stringent requirements for ensuring that all power supplies/utilization equipment functions together properly.

For power supply equipment, additional monitoring features are implemented to detect and isolate equipment, or groups of equipment, that can experience power quality issues. The intended purpose of this isolation capability is to enable protection of the other operating power supplies and utilization equipment.

For power utilization equipment, strict power quality requirements have been imposed. Some reasons for that are listed below:
Equipment contributing to power quality problems causes other equipment to fail.
Equipment is prevented from achieving its design performance or reliability due to the reduced power quality of the source.
Equipment designed with no power margin, perhaps to meet a desired minimum weight, tends to be more susceptible to power quality issues. Also, equipment designed to minimize weight tends to create power quality issues.
Equipment can fail due to self-generated power quality problems.

Power quality requirements for AC electrical equipment consist of a large number of parameters. These parameters include current distortion, inrush current, voltage distortion, voltage modulation, power factor, phase balance and DC content.

The issue of electrical current distortions composed of AC harmonics is a key design driver for equipment. The requirements for current harmonics, subharmonics, and interharmonics specify the allowable distortion as a function of multiples of the fundamental frequency of the input voltage.

A typical current harmonic includes all odd harmonics up to 39, with limits ranging from 10 to 0.25 percent of the maximum current fundamental. The current distortion requirement is a key design driver because it usually significantly impacts equipment weight.

Electrical current distortion also is specified as a function of equipment-rated power because the higher-power equipment has more influence on the power bus.

DC output requirements, including ripple voltage and voltage droop, are also important for AC-to-DC converters. Ripple voltage and voltage droop determine the DC operating range of output equipment such as inverters.

Historically, passive AC-to-DC converters have dominated the aerospace power electronics industry. This has been true for several reasons, including simplicity, lack of stringent power quality requirements, lack of stringent EMI compliance requirements, and no need for regeneration of electric power to the distribution bus.

Passive AC-to-DC converters usually comprise diodes and filtering capacitors. They are characterized by low losses, high reliability, and relatively low weight and volume. The main representative for a three-phase distribution bus is the three-phase diode bridge, which comprises six diodes and one smoothing capacitor in its minimal configuration. The main disadvantages of this converter type are the high level of harmonic content in the input currents caused by the six-step commutation, and the inability to transfer power to the opposite direction.

As a part of the MEA initiative, increased-power-level electronics equipment has been installed on the latest platforms. This has resulted in large quantities of utilization hardware being connected to the same distribution bus. That development has created a more complex relationship between various loads and the power generation system. Well-defined, stringent power quality and EMI compliance requirements have been devised in an effort to mitigate the effects of that growing complexity. For example, the conventional three-phase diode bridge does not satisfy the new environment. Complex passive filters must be added for input harmonic compliance, which leads to a substantial weight penalty.

Another improvement to the three-phase diode bridge has been made by implementing various passive schemes with an increased number of commutation steps: the larger the number of rectified phases, the lower the amplitudes of the input harmonics. Also, some low-frequency harmonics disappear with larger commutation frequency. The high-frequency harmonics are easy to mitigate with smaller inductors and capacitors. To increase the number of commutation steps from 6 to 12 or 18, the three-phase distribution bus has to be converted to a six- or nine-phase bus and then rectified. A great variety of transformers and autotransformers can be used to perform those tasks. It is believed that 18-pulse converters are larger than 12-pulse converters. So designed multi-pulse AC-to-DC converters experience increased weight and volume, worse losses, and reduced reliability. However, at this point, these solutions look most attractive for medium-to-low-power applications in which unidirectional power transfer only is required.

The drive for energy-efficient aircraft postulated the need for bidirectional power transfer. This created an opportunity to reuse the regenerated power coming from some loads like electrical actuators. Active rectification came along to satisfy this complex task. Some active rectification topologies are not bidirectional, e.g., Vienna rectifiers. The most common bidirectional active rectifier is a three-phase bridge that comprises six diodes, six switching devices, a DC link capacitor, and three interface inductors for decoupling with the distribution bus. To implement proper high-performance operation, sophisticated vector control algorithms are required. This leads to use of additional DSP-based control electronics with a gate driver for each switching device. Power quality compliance is relatively easy due to controllability of the wave shape of the input currents. EMI compliance, on the other hand, is probably more difficult due to differential and common mode noises emitted by the switching devices. Quite competitive AC-to-DC converters with bidirectional capability have been obtained. However, reliability in such cases has been drastically reduced due to the increased number of components and the connections between them. The conclusion from the foregoing is that there is a great variety of active rectifiers with variations in their characteristics. The success of each of them varies from one application to another. Therefore, no clear overall winner has emerged.

It is believed that in power levels above 25 KVA, active rectification is preferable for purposes of reducing weight and volume. Consequently, if there is no need for bidirectional operation and the power levels are below certain levels, passive multi-pulse rectification is the preferred option.

Historically, passive AC-to-DC converters have dominated the aerospace industry because of their greater simplicity and higher reliability.

The term “composite AC-to-DC converter” was coined to distinguish a converter using two or more conversion methods in parallel by use of an asymmetrical autotransformer. The concept for a composite AC-to-DC converter originated as a further improvement in the direction of smaller size, lower weight, and greater efficiency for an asymmetrical autotransformer, which was originally described in U.S. Pat. No. 6,396,723, “Rectifier and Transformer Thereof”. That patent limited itself to characterizing several 12- and 18-pulse autotransformer systems. Another patent, U.S. Pat. No. 6,498,736, “Harmonic Filter with Low Cost Magnetics,” describes asymmetrical autotransformers more generally and details a few DELTA constructed configurations.

While the discussed composite converters present a significant step toward performance improvement compared to state-of-the-art converters, there are still opportunities for further advancement in this area.

Six-pulse rectification schemes produce predictable harmonics as formulated in Equation 1:

F(h)=(k*q+/−1)*f1 (1)

where:
F(h) is the characteristic harmonic,
k is an integer beginning with 1,
q is an integer representing the number of commutations/cycle, and
f1 is the fundamental frequency.

The characteristic current harmonics of a six-pulse rectification system include the 5th, 7th, 11th, 13th, 17th, 19th, and 23rd of the fundamental. These harmonics have considerable magnitude and, for the six-pulse system, can exceed 33 percent of the fundamental.

Theory predicts that going to higher-pulse rectifier systems will reduce the electrical current THD of a system. For example, a 12-pulse rectifier may have about 8.5 percent current THD (no harmonic below the 11th), an 18-pulse rectifier may have about 3 percent current THD (no harmonic below the 17th), and a 24-pulse rectifier may have about 1.5 percent current THD (no harmonic below the 23rd).

Autotransformer conversion ratio (ACR) is used to aid in comparing different types of autotransformers that are based on AC-to-DC converters. It is based on the equation of equivalent kVA rating (see Equation 2). Equation 3 is used as a tool to aid in comparing converters having different sizes and weights:

Equivalent kVA=0.5*Σ(Vrms*Irms)/1000 (2)

where
Vrms are the voltages at each individual winding in volt-rms values, and
Irms are the currents in each individual winding in amps-rms values.

ACR=2*IDCout*VDCout/Σ(Vrms*Irms) (3)

where
VDC out is the output rectified voltage in volts,
IDC out is the output rectified current in amps,
Vrms are the voltages at each individual winding in volt-rms values,
Irms are the currents in each individual winding in amps-rms values, and the units of the ACR are W/VA.

Using this equation, U.S. Pat. No. 6,995,993 describes power conversion with an ACR of 1.53 W/VA. This is a symmetric autotransformer presently used in the A350 VCRUMC and CDMMC controller designs. U.S. Pat. No. 6,396,723 for 12-pulse and 18-pulse asymmetric autotransformers exhibits improved ACR numbers. The estimated ACR for the smallest 18-pulse autotransformer from U.S. Pat. No. 6,396,723 is 3.53 W/VA. The ACR difference indicates that the asymmetric 18-pulse autotransformer has the potential of being only 0.43 the size and weight of an equivalent symmetric type. The reduced size and weight of the asymmetrical autotransformer, along with the inherent efficiency improvement from having less VA in its windings, makes composite AC/DC conversion attractive.

All the asymmetrical autotransformers used in the composite systems satisfy a construction diagram using the vertices of an equilateral triangle and an arc swung between them equal to the length of one of the triangle legs. The number of autotransformer phase outputs is then determined by the number of equally spaced rays drawn from the midpoint of the equilateral triangle. The intersection points of these rays with the arc are used to design the autotransformer windings voltage ratios and interconnections. An autotransformer designed this way has output voltages of lower amplitude than the voltage source, while the voltage source line-to-line amplitude alone fixes the DC output level of the system. Because of the voltage differences of the autotransformer output, the load current splits into two paths. A large portion of the load current bypasses the autotransformer and is rectified directly through a main rectifier bridge. The remainder of the load current flows through the autotransformer and is rectified by auxiliary bridge rectifiers.

Several examples of asymmetric autotransformers from the former art are shown in FIGS. 1 through 3. All are depicted with line segments of various lengths, scaled to the number of winding turns, drawn in a direction representing the respective 3-phase transformer leg on which it is wound.

There is a need yet for improvements in composite AC-to-DC power conversion systems and methods.

### SUMMARY OF THE INVENTION

In one aspect of the present invention, a composite AC-to-DC power converter comprises an asymmetric autotransformer where each leg of the autotransformer satisfies a WYE-architecture transformer vector diagram constructed using vertices of an equilateral triangle wherein an arc swung between the vertices is equal to a length of one leg of the triangle; a main bridge rectifier receiving a majority portion of current from an autotransformer; and a plurality of auxiliary bridge rectifiers, each receiving output from each leg of the autotransformer.

In another aspect of the present invention, a method for converting AC power to DC power with an AC-to-DC power converter comprises passing a first portion of a load current through a main rectifier; passing a second portion of a load current though an autotransformer, wherein each leg of the autotransformer satisfies a WYE-architecture transformer vector diagram constructed using vertices of an equilateral triangle wherein an arc swung between the vertices is equal to a length of one leg of the triangle; and rectifying the output from the autotransformer with a plurality of auxiliary bridge rectifiers, each of the auxiliary bridge rectifiers receiving the output from each leg of the autotransformer.

In a further aspect of the present invention, a method for reducing the total harmonic distortion (THD) of an AC-to-DC power converter comprises passing a substantial portion of a load current through a main rectifier; passing the remaining portion of a load current though an autotransformer, wherein each leg of the autotransformer satisfies a WYE-architecture transformer vector diagram constructed using vertices of an equilateral triangle wherein an arc swung between the vertices is equal to a length of one leg of the triangle; and rectifying the output from the autotransformer with a plurality of auxiliary bridge rectifiers.

These and other features, aspects and advantages of the present invention will become better understood with reference to the following drawings, description and claims.

### BRIEF DESCRIPTION OF THE DRAWINGS

FIG. 1 is a construction diagram of a 12-pulse asymmetric autotransformer according to the prior art;

FIG. 2 is a construction diagram of an 18-pulse asymmetric autotransformer according to the prior art;

FIG. 3 is a construction diagram of another 18-pulse asymmetric autotransformer according to the prior art;

FIG. 4 is a construction diagram of a WYE architecture, asymmetric autotransformer for a 12-pulse AC-to-DC composite system according to an exemplary embodiment of the present invention;

FIG. 5 is a construction diagram of a WYE architecture, asymmetric autotransformer for an 18-pulse AC-to-DC composite system according to an exemplary embodiment of the present invention;

FIG. 6 is a construction diagram of a WYE architecture, asymmetric, midpoint autotransformer for a 24-pulse AC-to-DC composite system according to an exemplary embodiment of the present invention;

FIG. 7 is a construction diagram of one leg of the 12-pulse AC-to-DC composite system of FIG. 4;

FIG. 8 is a construction diagram of one leg of the 18-pulse AC-to-DC composite system of FIG. 5;

FIG. 9 is a construction diagram of one let of the 24-pulse AC-to-DC composite system of FIG. 6; and

FIG. 10 shows an exemplary circuit diagram of a power conversion system that may use WYE architecture asymmetric autotransformers.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention provide a composite power conversion method for converting electrical power from AC to DC. The composite power conversion method uses two or more conversion methods in parallel and provides a passive technique that “splits” the input 3-phase voltages into additional phases, using a WYE asymmetrical autotransformer, so that the number of DC rectification pulses is increased. The WYE asymmetric autotransformer intakes only a fraction of the 3-phase input current thus reducing its losses.

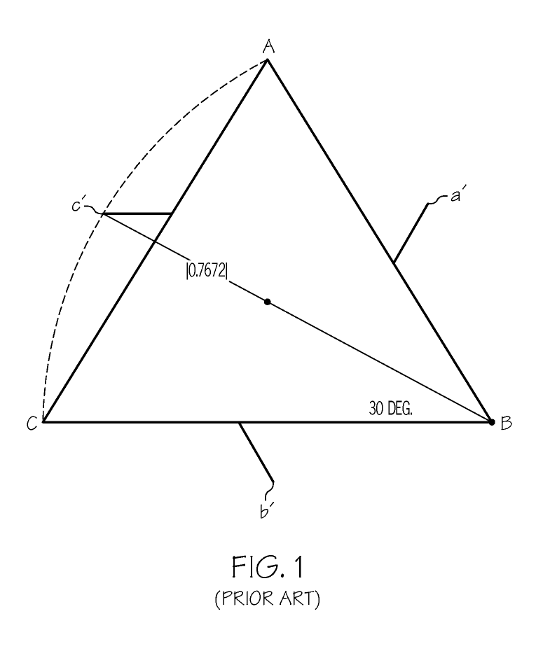

As described above, several examples of asymmetric autotransformers from the former art are shown in FIGS. 1 through 3. All are depicted with line segments of various lengths, scaled to the number of winding turns, drawn in a direction representing the respective 3-phase transformer leg on which it is wound.

It can be determined that the sum of the lengths of the autotransformer configuration line segment has an inverse relationship to the ACR number calculated for comparing its AC-to-DC conversion efficiency. The smaller the sum of lengths, the higher the ACR number or, the more efficient the W/VA for an autotransformer in accomplishing AC to DC conversion.

Among asymmetrical 18-pulse autotransformer configurations, the smallest line segment length sum is obtained from using WYE construction vectors, not DELTA vectors. To illustrate this, autotransformer DELTA constructions for 12- and 18-pulse configurations described in U.S. Pat. Nos. 6,396,723 and 6,498,736 are compared by normalizing the line segments sums found in their construction diagrams with that from a WYE-architecture construction diagram. Simulations yielding ACR numbers are compared with proposed 12- and 18-pulse WYE constructions.

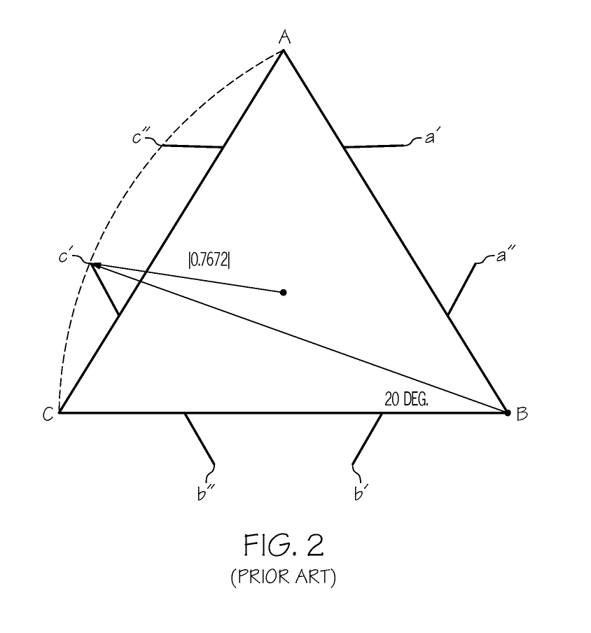

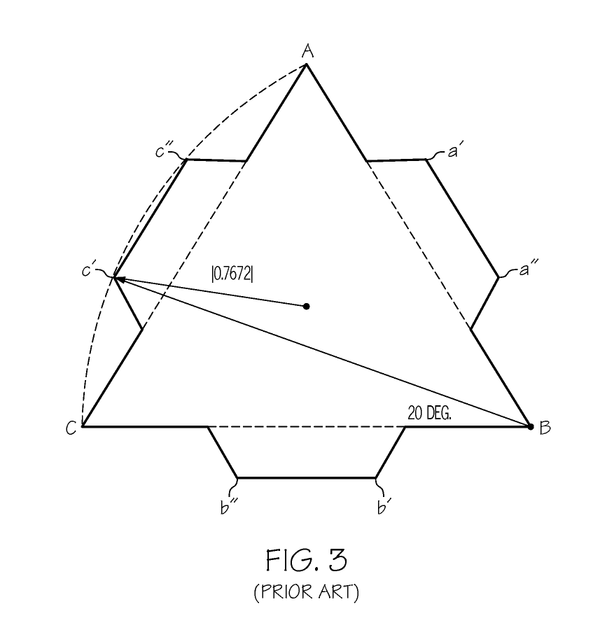

Using a normalizing number equal to 3*1.7321=5.1962 (the perimeter of the equilateral triangle shown in FIG. 3), the following measurements are determined. For U.S. Pat. No. 6,396,723 (FIG. 1), the smallest line segment sum (normalized) for a 12-pulse configuration is 6.0/5.1962=1.1547. Similarly, for U.S. Pat. No. 6,498,736 (FIG. 1), the smallest line segment sum (normalized) for a 12-pulse configuration is 6/5.1962=1.1547. For U.S. Pat. No. 6,396,723 (FIG. 3) the smallest line segment sum (normalized) for an 18-pulse configuration is 5.9085/5.1962=1.1371. For U.S. Pat. No. 6,498,736 (FIG. 2), the smallest line segment sum (normalized) for an 18-pulse configuration is 6.6212/5.1962=1.2742. For a 24-pulse configuration, only U.S. Pat. No. 6,498,736 proposes one. For that assumed configuration, the smallest line segment sum (normalized) is 7.4249/5.1962=1.4289.

The WYE-architecture-constructed asymmetrical autotransformer configurations, according to exemplary embodiments of the present invention, result in the least line segment sums and are potentially the most efficient for AC-to-DC conversion of all asymmetric autotransformer configurations. The reason that these WYE configurations have smaller line segment sums is because the single line segment at the AC inputs needs only to be counted once per phase, where in the DELTA configurations all segments must be counted twice. The smallest line segment sum (normalized) for a 12-pulse configuration is 5.5.1962/5.1962=1.0000. The smallest line segment sum (normalized) for a vertex 18-pulse configuration is 5.6385/5.1962=1.0851. The smallest line segment sum (normalized) for a midpoint 18-pulse configuration is 5.5869/5.1962=1.0752. The smallest line segment sum (normalized) for a midpoint 24-pulse configuration is 5.7444/5.1962=1.1055.

If the DELTA and WYE line segment sums are compared, a sense of relative performance can be deduced. For the 12-pulse configurations, the WYE-constructed autotransformer is anticipated to be 0.866 smaller than that of the former art. For the 18-pulse transformers, the WYE-constructed midpoint autotransformer is anticipated to be 0.9456 smaller than that of U.S. Pat. Nos. 6,396,723, and 0.7421 smaller than that of U.S. Pat. No. 6,498,736. For the 24-pulse transformers, the WYE-constructed midpoint autotransformer is anticipated to be 0.7737 smaller than that of U.S. Pat. No. 6,498,736.

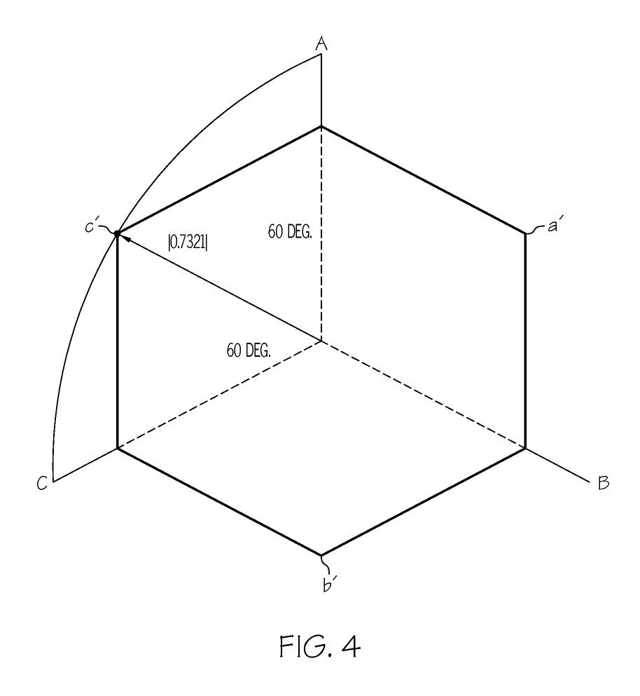

A midpoint WYE-architecture, asymmetric, 12-pulse autotransformer construction diagram is shown in FIG. 4. A simulation of these 12-pulse AC-to-DC converters supplying a 10-kW resistive load yielded ACR's that could be predicted by looking at the sums of the line segments of the various configurations. In the simulation, the equivalent kVA for the 12-pulse asymmetric autotransformer from the former art was 2.785. The WYE-based, 12-pulse asymmetric autotransformer configuration, according to embodiments of the present invention, (similarly loaded) had an equivalent kVA of 2.204. The ACR improvement is 25% over the ACR of the mentioned former art. This WYE configuration permits a boost topology that has no AC phase shift input to output, but that has a reduced ACR.

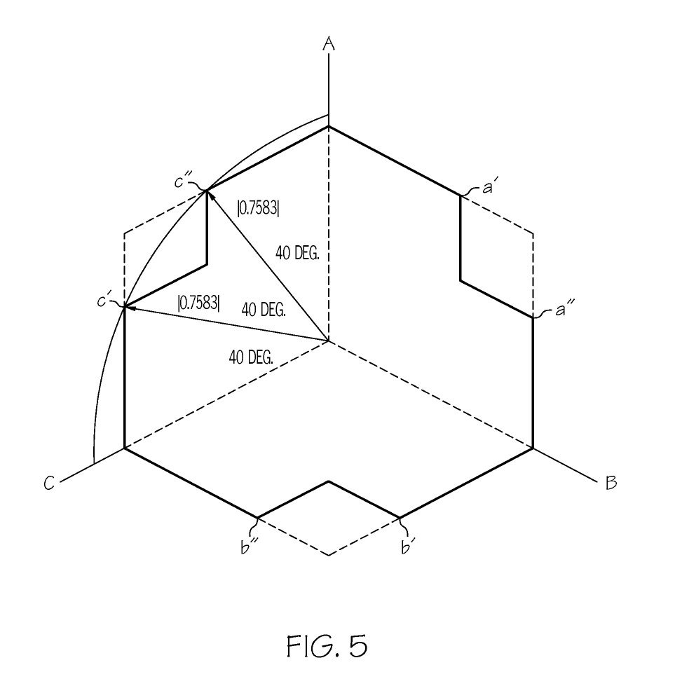

FIG. 5 shows a midpoint WYE-architecture, asymmetric, 18-pulse autotransformer construction diagram. Two realizations, equivalent in performance, are possible (one is shown by the dotted line). The asymmetric transformer AC inputs are at points A, B and C. The outputs are at a′, a″, b′, b″, c′, c″. This WYE configuration permits a boost topology with no AC phase shift input to output, but a reduced ACR.

A simulation of these 18-pulse AC-to-DC converters supplying a 10-kW resistive load yielded ACR's that could be predicted by looking at the sums of the line segments of the various configurations. In the simulation, the lowest equivalent kVA for the 18-pulse asymmetric autotransformer from the former art was 2.6978 (U.S. Pat. No. 6,396,723). The WYE-based (midpoint) 18-pulse asymmetric autotransformer configuration, according to embodiments of the present invention, (similarly loaded) had an equivalent kVA of 2.5936. The ACR improvement is greater than 4%. In the simulation, the lowest equivalent kVA for the 18-pulse asymmetric autotransformer from the former art was 3.0695 (U.S. Pat. No. 6,498,736). The ACR improvement is greater than 18%.

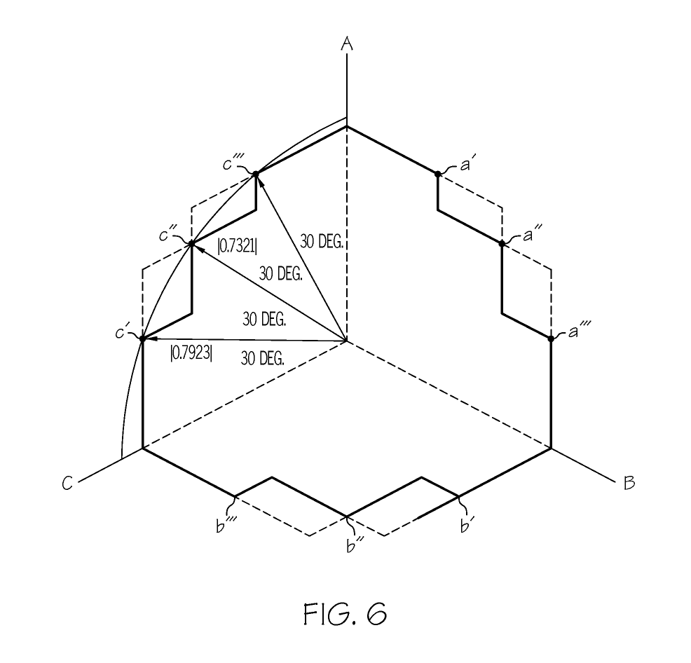

The midpoint WYE-architecture, asymmetric, 24-pulse autotransformer construction diagram is shown in FIG. 6. Two realizations in performance are possible (one is shown by the dotted line.) The asymmetric transformer AC inputs are at points A, B and C. The outputs are at a′, a″, a′″, b′, b″, b′″, c′, c″, c′″. This WYE configuration permits a boost topology that has no AC phase shift input to output, but that has a reduced ACR.

A simulation of these 24-pulse AC-to-DC converters supplying a 10-kW resistive load yielded ACR's that could be predicted by looking at the sums of the line segment lengths of the various configurations. The ACR improvement over the configuration mentioned in U.S. Pat. No. 6,498,736 is predicted to be greater than 20%.

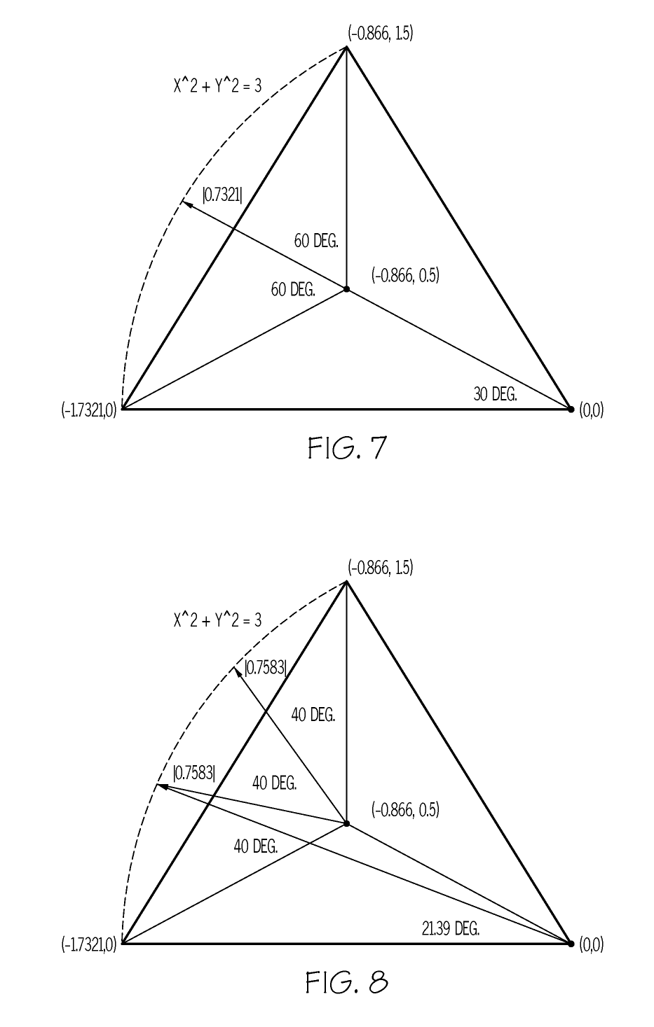

One “leg” of the diagram for a proposed 12-pulse autotransformer is shown in FIG. 7. Many vector combinations exist that will achieve the coordinates of intersection of the single ray and arc needed for this 12-pulse configuration. Using WYE architectures can yield the most efficient VA/W (volt-amperes/watt) construction.

One “leg” of the diagram for a proposed midpoint 18-pulse autotransformer is shown in FIG. 8. Many vector combinations exist that will achieve the coordinates of intersection of the two rays and arc needed for this 18-pulse configuration. Using WYE architectures can yield the most efficient VA/W (volt-amperes/watt) construction. This midpoint autotransformer diagram determines winding turn ratios that differ from the U.S. Pat. No. 6,396,723 autotransformer of similar configurations. The midpoint method also further reduces the total sum of line segment lengths needed for implementing an asymmetric autotransformer design.

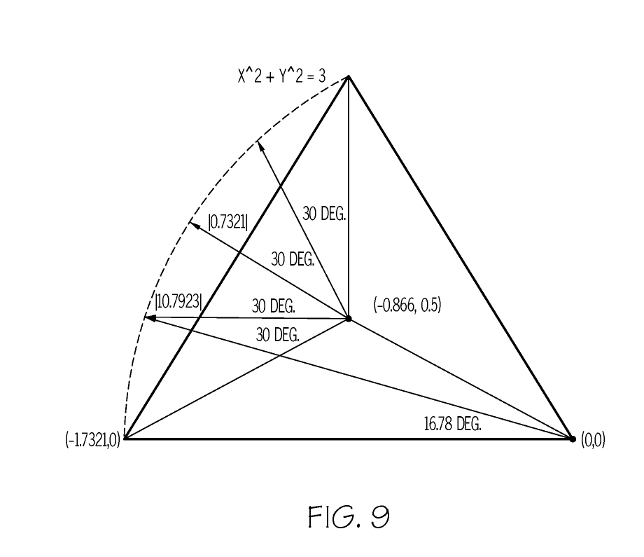

One “leg” of the diagram for a proposed midpoint 24-pulse autotransformer is shown in FIG. 9. Many vector combinations exist that will achieve the coordinates of intersection of the three rays and arc needed for this 24-pulse configuration. Using WYE architectures can yield the most efficient VA/W (volt-amperes/watt) construction.

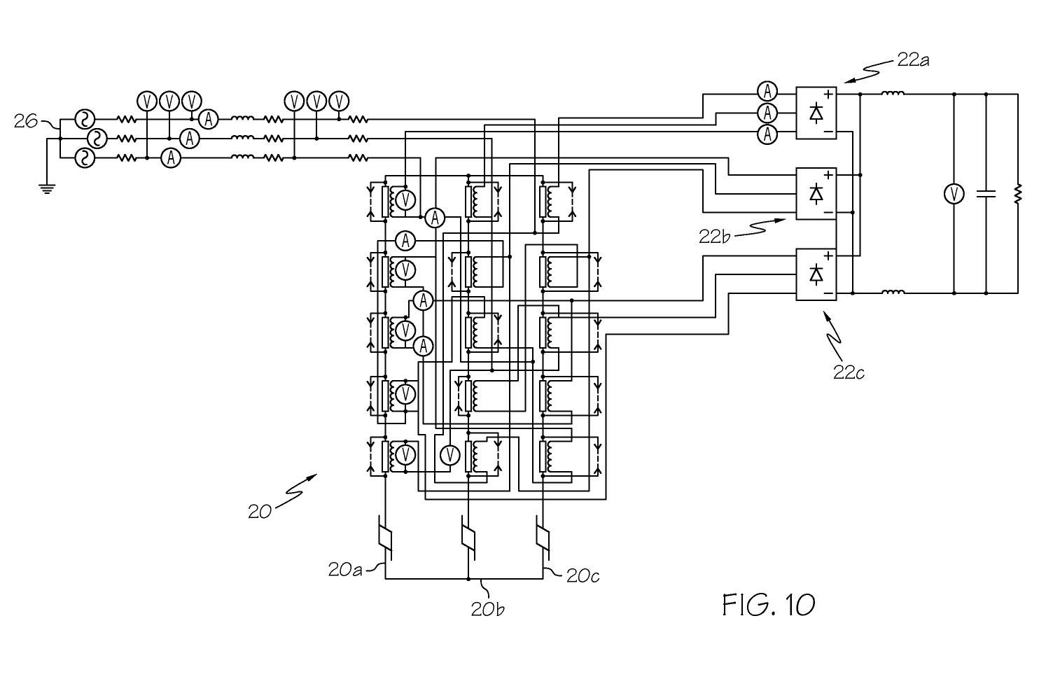

FIG. 10 shows an exemplary circuit diagram of a power conversion system that may use WYE architecture asymmetric autotransformers. The windings associated with each of the three-phase autotransformer legs are grouped within dashed-line rectangles 20a, 20b, 20c. The output from each of the autotransformer legs 20a, 20b, 20c may pass through auxiliary rectifiers 22a, 22b, 22c. An input AC waveform 26 may be split with a substantial portion of load current being rectified through a main 6-diode rectifier bridge 24 and the remaining portion of load current flowing through an autotransformer 20 to be rectified by the auxiliary bridge rectifiers 22a, 22b, 22c.

The method for composite AC-to-DC WYE architecture power conversion according to embodiments of the present invention presents the following advantages:
The ACR of the WYE-architecture conversion methods of the present invention show a significant improvement over that of the former art.
During transient input voltages, the converter would act in a stable manner.
The efficiency is very high since a large part of the power flows through the main six-pulse rectifier.
Reduced weight because a large portion of the power is converted by a simple six-pulse rectifier.
The electric drive operates in a more optimized mode due to reduced DC voltage variation. This is in line with the latest MEA tendency for energy-optimized aircraft
The methods of the present invention can be easily used in retrofit applications because it presents reduced volume, weight, and losses.
Although applications of this AC-to-DC composite converter are considered to be for power systems less than 25 kW, the system is not inherently power limited.

It should be understood, of course, that the foregoing relates to exemplary embodiments of the invention and that modifications may be made without departing from the spirit and scope of the invention as set forth in the following claims.

We claim:

1. A composite AC-to-DC power converter comprising:
an asymmetric autotransformer where each leg of the autotransformer satisfies a WYE-architecture transformer vector diagram constructed using vertices of an equilateral triangle wherein an arc swung between the vertices is equal to a length of one leg of the triangle;
a main bridge rectifier receiving a majority portion of current from an autotransformer; and
a plurality of auxiliary bridge rectifiers, each receiving output from each leg of the autotransformer.

2. The power converter of claim 1, wherein a number of autotransformer phase outputs is determined by a number of rays drawn from a midpoint of the equilateral triangle.

3. The power converter of claim 1, wherein a number of autotransformer phase outputs is determined by a number of rays drawn from a vertex of the equilateral triangle.

4. The power converter of claim 1, wherein the autotransformer satisfies a WYE-architecture, asymmetric, 12-pulse autotransformer construction diagram.

5. The power converter of claim 1, wherein the autotransformer satisfies a midpoint or vertex WYE-architecture, asymmetric, 12-pulse autotransformer construction diagram.

6. The power converter of claim 1, wherein the autotransformer satisfies a midpoint or vertex WYE-architecture, asymmetric, 18-pulse autotransformer construction diagram.

7. The power converter of claim 1, wherein the autotransformer satisfies a midpoint or vertex WYE-architecture, asymmetric, 24-pulse autotransformer construction diagram.

8. A method for converting AC power to DC power with an AC-to-DC power converter, the method comprising:
passing a first portion of a load current through a main rectifier;
passing a second portion of the load current though an autotransformer, wherein each leg of the autotransformer satisfies a WYE-architecture transformer vector diagram constructed using vertices of an equilateral triangle wherein an arc swung between the vertices is equal to a length of one leg of the triangle; and
rectifying the output from the autotransformer with a plurality of auxiliary bridge rectifiers, each of the auxiliary bridge rectifiers receiving the output from each leg of the autotransformer.

9. The method of claim 8, further comprising minimizing loss from the autotransformer by providing, to the autotransformer, the second portion which is a fraction of the total AC input.

10. The method of claim 8, wherein the first portion is a substantial portion of the load current and the second portion is the remaining portion of the load current.

11. The method of claim 8, wherein a number of autotransformer phase outputs is determined by a number of rays drawn from a midpoint or vertex of the equilateral triangle.

12. The method of claim 8, further comprising constructing the autotransformer through a midpoint or vertex, WYE-architecture, asymmetric, 12-pulse autotransformer construction diagram.

13. The method of claim 8, further comprising constructing the autotransformer through a midpoint or vertex, WYE-architecture, asymmetric, 18-pulse autotransformer construction diagram.

14. The method of claim 8, further comprising constructing the autotransformer through a midpoint or vertex, WYE-architecture, asymmetric, 24-pulse autotransformer construction diagram.

15. A method for reducing the total harmonic distortion (THD) of an AC-to-DC power converter, the method comprising:
passing a substantial portion of a load current through a main rectifier;
passing the remaining portion of a load current though an autotransformer, wherein each leg of the autotransformer satisfies a WYE-architecture transformer vector diagram constructed using vertices of an equilateral triangle wherein an arc swung between the vertices is equal to a length of one leg of the triangle; and
rectifying the output from the autotransformer with a plurality of auxiliary bridge rectifiers.

16. The method of claim 14, wherein the output of the AC-to-DC power converter results in very small harmonics to the input current.

17. The method of claim 14, wherein a number of autotransformer phase outputs is determined by a number of rays drawn from a midpoint or vertex of the equilateral triangle.
